(19) United States
(12) Patent Application Publication
(10) Pub. No.: US 2012/0124169 A1
(43) Pub. Date: May 17, 2012

(54) TRANSMITTING DATA FROM A COMPUTER TO A PLURALITY OF DEVICES

(76) Inventors: Mark C. Solomon, San Jose, CA (US); Rahul Sood, Calgary (CA)

(21) Appl. No.: 13/386,964

(22) PCT Filed: Aug. 27, 2009
(86) PCT No.: PCT/US09/55260

§ 371 Date: Jan. 25, 2012

(51) Int. Cl. G06F 15/16; H04W 8/00

(52) U.S. Cl. 709/217

(57) ABSTRACT

Data is transmitted from a computer (260A, 260B) to a plurality of viewing devices (270, 280). First video data is received (320) at an apparatus (100) from a computer (260A, 260B) through a data interface (210) associated with the computer (260A, 260B). The first video data is transmitted (330) wirelessly from the apparatus (100) to a wireless receiver (272) associated with a first viewing device (270). Second data is transmitted (340) from the computer (260A, 270A) to a second viewing device (280) through the computer (260A, 270A)'s data interface (210) and a wireless-pass-through-component (140), which is a part of the apparatus (100).

### BACKGROUND

As videos are becoming available on the Internet, more people want to watch Internet provided videos on their televisions (TVs). Typically people run cables from their computer in their home offices to their TVs located in their living room or family room. Holes are drilled through walls and floors in order to connect the cables between their computer and their television. Further, computers provide a limited number of connection slots for connecting cables. Therefore, running a cable from the computer to the television uses one of the few, connection slots, if not the only connection slot, provided by the computer.

### BRIEF DESCRIPTION OF THE DRAWINGS

The accompanying drawings, which are incorporated in and form a part of this Description of Embodiments, illustrate various embodiments of the present invention and, together with the description, serve to explain principles discussed below:

FIG. 1 depicts a block diagram of an apparatus for transmitting data from a computer to a plurality of devices, according to one embodiment.

FIG. 2A depicts a block diagram of a system for transmitting data from a computer to a plurality of devices using an apparatus that is separate from the computer, according to one embodiment.

FIG. 2B depicts a block diagram of a system for transmitting data from a computer to a plurality of devices using an apparatus that resides on the computer, according to one embodiment.

FIG. 3 depicts a block diagram of a flowchart for a method of transmitting data from a computer to a plurality of devices, according to one embodiment.

The drawings referred to in this Brief Description should not be understood as being drawn to scale unless specifically noted.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in the following Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Unless specifically stated otherwise as apparent from the following discussions, it is appreciated that throughout the present Description of Embodiments, discussions utilizing terms such as “configuring,” “receiving,” “transmitting,” “transforming,” “transforming data to change the state of a device,” or the like, refer to the actions and processes of a computer system, or electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. Some embodiments of the subject matter are also well suited to the use of other computer systems such as, for example, optical and virtual computers.

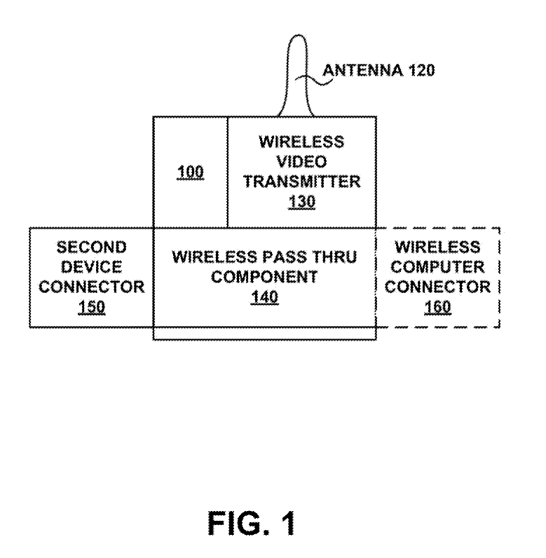

FIG. 1 depicts a block diagram of an apparatus 100 for transmitting data from a computer to a plurality of devices, according to one embodiment. As depicted in FIG. 1, the apparatus 100 includes an antenna 120, a wireless video transmitter 130, a wireless pass thru component 140, and a second device connector 150. The apparatus 100 may include an optional wireless computer connector 160.

According to one embodiment, the wireless computer connector 160 is communicatively coupled to the wireless pass thru component 140 and the wireless video transmitter 130. The second device connector 150 can be used to connect a cable to the apparatus 100 or can be used to transmit data wirelessly from the apparatus 100 to another device, such as a computer monitor.

According to one embodiment, any one or more of the wireless video transmitter 130, the antenna 120, the wireless pass thru component 140, the wireless computer connector 160, and the second device connector 150 are hardware components. According to one embodiment, an apparatus 100 includes some software or firmware components. For example, the wireless video transmitter 130, the, wireless pass thru component 140, the second device connector 150, among other things, may be implemented with hardware, software, firmware, or a combination thereof.

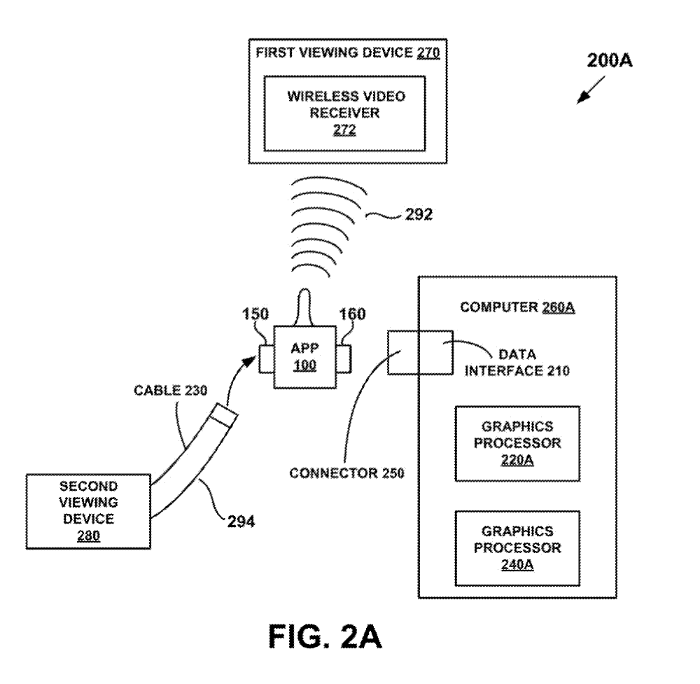

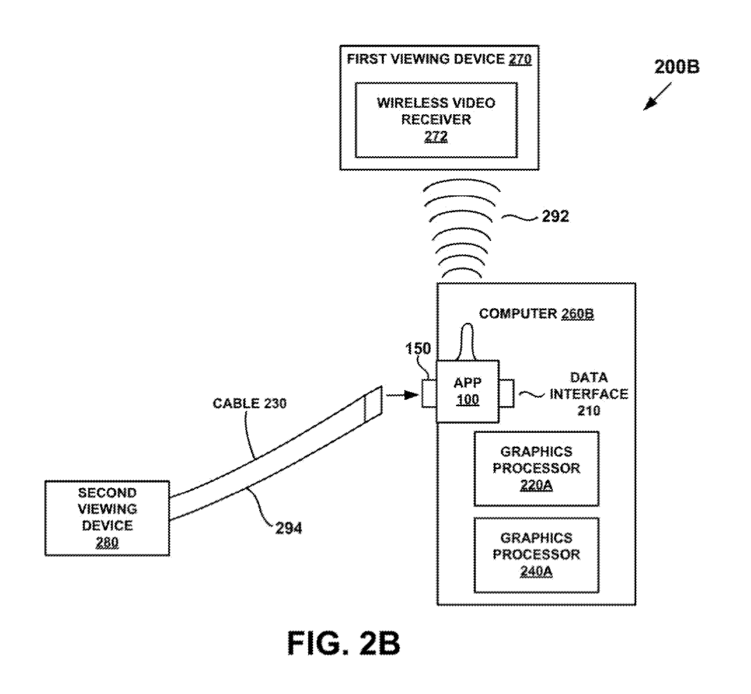

The apparatus 100 can be physically separate from a computer as depicted in FIG. 2A or can reside on a computer as depicted in FIG. 2B. An apparatus 100 that is separate from a computer is also referred to as a “dongle.”

FIG. 2A depicts a block diagram of a system 200A for transmitting 292, 294 data from a computer 260A to a plurality of devices 270, 280 using an apparatus 100 that is separate from the computer 260A, according to one embodiment. Assume that a wireless video receiver 272 is associated with the first viewing device 270, such as a television. The receiver 272 may reside in the first viewing device 270 or may be separate and communicatively coupled to the first viewing device 270.

Referring to FIGS. 1 and 2A, in the event that the apparatus 100 (FIG. 1) is physically separate from the computer 260A, as depicted in FIG. 2A, the apparatus 100 may also include the optional wireless computer connector 160 that can be used to connect an apparatus 100 to a computer 260A's connector 250. The connector 250 may used for transmitting data that conforms to any one or more standards such as High Definition (HD), High Definition Multimedia Interface (HDMI), Video Graphics Array (VGA), and Digital Visual Interface (DVI). Many computers have only one HD connection slot.

As depicted in FIG. 2A, a cable 230 can be used to connect a second viewing device 280, such as a computer monitor, with the apparatus 100 (FIG. 1), according to one embodiment. The cable 230 can be inserted into the second device connector 150 associated with the apparatus 100. According to another embodiment, the apparatus 100 can use its second device connector 150 to communicate 294 data wirelessly to the second viewing device 280.

Still referring to FIGS. 1 and 2A, the apparatus 100 can receive video data from a graphics processor 220A that resides on the computer 260A through the computer 260A's data interface 210. The apparatus 100's wireless video transmitter 130 transmits 292 the received video to a first viewing device 270 using the apparatus 100's antenna 120. A wireless video receiver 272 associated with the first viewing device 270 can receive the video data that was transmitted 292 by the antenna 120.

The video data can also be communicated 294 to the second viewing device 280. For example, the same video data can be communicated from the same graphics processor 220A to the computer 260A's data interface 210. The video data can be transmitted from the data interface 210 to the apparatus' 100 wireless pass thru component 140 through the computer 260A's connector 250 and the apparatus' 100 connector 160. The video data can be transmitted 294 from the wireless pass thru component 140 to the second viewing device 280 through the cable 230 that is inserted into the apparatus' (100) second device connector 150. Thus, according to one embodiment, the apparatus 100 can transmit 292, 294 video data from a computer 260A to a plurality of viewing devices 270, 280, using one computer data interface 210.

As described above, the first viewing device 270 and the second viewing device 280 both received the same video data from at least one graphics processor 220A associated with the computer 260A. According to one embodiment, different video data can be transmitted 292, 294 to the viewing devices 270, 280. For example, a first video data can be transmitted 292 from a first graphics processor 220A to a first viewing device 270 as described above. Second video data can be transmitted 294 from a second graphics processor 240A to the second viewing device 280 by transmitting the second video data from the graphics processor 240A to the data interface 210 and so on to the second viewing device 280, as described herein. Thus, according to one embodiment, the apparatus 100 can transmit 292, 294 a plurality of videos to a plurality of devices 270, 280, using one computer data interface 210.

According to one embodiment, an apparatus 100 communicates 292 wirelessly with a first viewing device 270 and communicates 294 over a wire, such as cable 230, to a second viewing device 280. According to one embodiment, an apparatus 100 can be used to wirelessly transmit 292, 294 data from a computer 260A to a plurality of viewing devices 270, 280. For example, the apparatus' 100 second device connector 150 can transmit 294 data wirelessly to the second viewing device 280 just as the apparatus 100 transmits 292 data wirelessly to the first viewing device 270, according to one embodiment.

FIG. 2B depicts a block diagram of a system 200B for transmitting 292, 294 data from a computer 260B to a plurality of devices 270, 280 using an apparatus 100 that resides on the computer 260B, according to one embodiment.

As depicted in FIG. 2B, a cable 230 can be used to connect a second viewing device 280 with the apparatus 100 (FIG. 1), according to one embodiment. The cable 230 can be inserted into the second device connector 150 associated with the apparatus 100. According to another embodiment, the apparatus 100 can use its second device connector 150 to communicate data wirelessly to the second viewing device 280.

Referring to FIGS. 1 and 2B, the apparatus 100 can receive video data from a graphics processor 220A that resides on the computer 260B through the computer 260B's data interface 210. The apparatus 100′s wireless video transmitter 130 transmits 292 the received video to a first viewing device 270 using the apparatus 100's antenna 120. A wireless video receiver 272 associated with the first viewing device 270 can receive the video data that was transmitted 292 by the antenna 120.

The video data can also be communicated 294 to the second viewing device 280. For example, the same video data can be communicated from the same graphics processor 220A to the computer 260B's data interface 210. The video data can be transmitted from the data interface 210 to the apparatus' wireless pass thru component 140 through the computer 260B's connector 250 and the apparatus' (100) connector 160. The video data can be transmitted 294 from the wireless pass thru component 140 to the second viewing device 280 through the cable 230 that is inserted into the apparatus' (100) second device connector 150. Thus, according to one embodiment, the apparatus 100 can transmit 292, 294 video data from a computer 260B to a plurality of viewing devices 270, 280, using one computer data interface 210.

As described above, the first viewing device 270 and the second viewing device 280 both received the same video data from at least one graphics processor 220A associated with the computer 260B. According to one embodiment, different videos can be transmitted to the viewing devices 270, 280. For example, a first video can be transmitted 292 from a first graphics processor 220A to a first viewing device 270 as described above. A second video can be transmitted 294 from a second graphics processor 240A to the second viewing device 280 by transmitting the second video from the graphics processor 240A to the data interface 210 and so on to the second viewing device 280 as described herein. Thus, according to one embodiment, the apparatus 100 can transmit 292, 294 a plurality of videos to a plurality of devices 270, 280, using one computer data interface 210.

According to one embodiment, an apparatus 100 communicates 292 wirelessly with a first viewing device 270 and communicates 294 over a wire, such as cable 230, to a second viewing device 280. According to one embodiment, an apparatus 100 associated with a computer 260A, 260B can wirelessly transmit 292, 294 a video to a plurality of viewing devices 270, 280. For example, the connector 150 associated with the apparatus 100 can be a wireless connection. The apparatus 100 can wirelessly transmit 292 a video to the first viewing device 270 using the antenna 120 and wirelessly transmit 294 the video to the second viewing device 280 using a wireless connector 150 (FIGS. 2A, 2B). If both of the transmissions 292 and 294 are wireless, then transmission 294 can be accomplished without using one of the computer 260B's connection slots.

According to one embodiment, referring to FIG. 1, the apparatus 100 conforms to a standard, such as High Definition (HD), High Definition Multimedia Interface (HDMI), Video Graphics Array (VGA), and Digital Visual Interface (DVI). For example, if the standard is HDMI, then according to one embodiment, the wireless computer connector 160, the wireless pass thru component 140 and the second device connector 150 are respectively a wireless HDMI computer connector, a wireless HDMI pass thru component, and an HDMI second device connector. Similarly, the data interface 210 associated with computers 260A and 260B (FIGS. 2A and 2B), which communicates with the apparatus 100, would be an HDMI interface, according to one embodiment.

The blocks that represent features in FIGS. 1, 2A, and 2B can be arranged differently than as illustrated, and can implement additional or fewer features than what are described herein. Further, the, features represented by the blocks in FIGS. 1, 2A, and 2B can be combined in various ways.

Referring to FIGS. 2A, and 2B, examples of viewing devices 270, 280 include, but are not limited to, televisions and computer monitors. The viewing devices 270, 280 that transmit 292, 294 data using one data interface 210 may be the same type of viewing devices or may be different types of viewing devices. For example, an apparatus 100 (FIG. 1) may be used to communicate with a plurality of viewing devices 270, 280 that are all televisions. In another example, an apparatus 100 may be used to communicate with a plurality of viewing devices 270, 280 that are all computer monitors. In a third example, an apparatus 100 may be used to communicate with one or more televisions and one or more computer monitors.

Although many of the embodiments are described in the context of an apparatus 100 (FIG. 1) communicating wirelessly with a television and communicating over a cable with a computer monitor, an apparatus 100 may be used to communicate over a cable with a television and wirelessly with a computer monitor. Further, an apparatus 100 can communicate wirelessly with a plurality of viewing devices and communicate over a cable with a plurality of viewing devices.

According to one embodiment, the same video is communicated 292, 294 to a plurality of viewing devices 270, 280 (FIGS. 2A, 2B) simultaneously. For example, the apparatus 100 (FIG. 1) can be used to communicate 292, 294 the same video to both of the viewing devices 270, 280, as described herein. For example, if the same video is being transmitted 292, 294 to both the first viewing device 270 and the second viewing device 280, then the video can be simultaneously transmitted 292, 294 to both of the viewing devices 270, 280 from at least one graphics processor 220A. In a second example, the apparatus 100 can communicate 292, 294 different videos simultaneously to a plurality of the viewing devices 270, 280, as described herein. For example, a first video could be transmitted 292 from a first graphics processor 220A to a first viewing device 270 and a second video could be transmitted 294 simultaneously from a second graphics processor 240A to the second viewing device 280.

According to one, embodiment, a computer 260A, 260B (FIGS. 2A, 26) would use at least one graphics processor 220A, 240A for each of the videos that could potentially be transmitted simultaneously. For example, if one video is being transmitted 292 or 294 then the computer 260A, 260B would use at least one graphics processor 220A. If two videos are being transmitted 292 and 294 simultaneously, then the computer 260A, 260B would use at least two graphics processors 220A, 240A. If three videos are being transmitted simultaneously, the computer 260A, 260B would use at least three graphics processors.

Although the example above described transmitting 292 a first video to the first viewing device 270 and transmitting 294 a second video to a second viewing device 280, the data that is transmitted 292, 294 may be non-video data. For example, a video may be transmitted 292 to the first viewing device 270 and a word document, an Extensible Markup Language (XML) file, or an email may be transmitted 294 to the second viewing device 280. In a second example, a word document, an XML file, or an email may be transmitted 292 to the first viewing device 270 and a video may be transmitted 294 to the second viewing device 280. In a third example, non-video data may be transmitted 292, 294 to both the first viewing device 270 and the second viewing device 280.

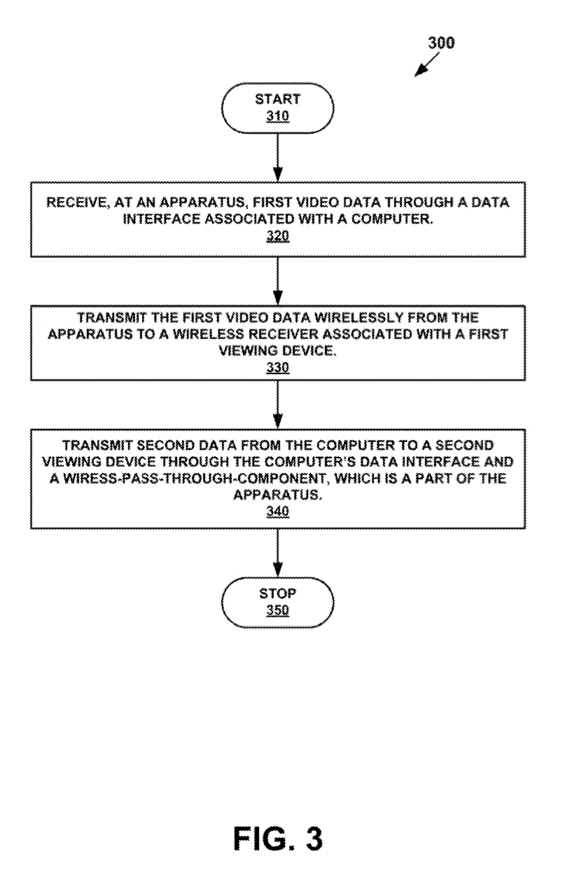

FIG. 3 depicts a block diagram of a flowchart for a method of transmitting data from a computer to a plurality of devices, according to one embodiment. Although specific steps are disclosed in flowchart 300, such steps are exemplary. That is, embodiments of the present invention are well suited to performing various other steps or variations of the steps recited in flowchart 300. It is appreciated that the steps in flowchart 300 may be performed in an order different than presented, and that not all of the steps in flowchart 300 may be performed.

The following description of method 300 refers to FIGS. 1, 2A, and 2B.

At 310, the method begins.

At 320, a video data is received at an apparatus 100 (FIG. 1) from a computer 260A, 260B (FIGS. 2A, 2B) through a data interface 210 associated with the computer 260A, 260B. For example, the data interface 210 can receive video data from a graphics processor 220A associated with a computer 260A, 260B. The data interface 210 can communicate the video data to the apparatus' 100 wireless video transmitter 130. The video data can be communicated to the wireless video transmitter 130 through a wireless computer connector 160 if the apparatus 100 is a dongle as depicted in FIG. 2A.

At 330, the video data is transmitted 292 (FIGS. 2A, 2B) wirelessly from the apparatus 100 (FIG. 1) to a wireless receiver 272 (FIGS. 2A, 2B) associated with a first viewing device 270 (FIGS. 2A, 2B). For example, the wireless video transmitter 130, associated with the apparatus 100, transmits 292 the received video data to a wireless receiver 272 that is associated with a first viewing device 270, such as a television.

At 340, second data is transmitted 294 (FIGS. 2A, 2B) from the computer 260A, 260B (FIGS. 2A, 2B) to a second viewing device 280 through the computer 260A, 260B's data interface 210 and a wireless pass through component 140 (FIG. 1), which is a part of the apparatus 100. For example, second data, such as an email or a word document, can be communicated 294 from a second graphics processor 240A associated with a computer 260A, 260B to a second viewing device 280. More specifically, the second data can be communicated from the second graphics processor 240A to a data interface 210 of a computer 260A, 260B. The second data can be communicated 294 to the second viewing device 280 through the apparatus 100, as described herein.

According to another embodiment, the second data that is transmitted 294 (FIGS. 2A, 2B) to the second viewing device 280 (FIGS. 2A, 2B) may be the same video that was transmitted 292 (FIGS. 2A, 2B) to the first viewing device 270 (FIGS. 2A, 2B) in 330. For example, the video that was transmitted 292 to the first viewing device 270 in 330 can also be transmitted 294 to the second device 280 by communicating the video from the first graphics processor 220A associated with a computer 260A, 260B, to the computer 260A, 260B's data interface 210, through the apparatus 100 (FIG. 1) to the second viewing device 280, as described herein.

At 350, the method ends.

Although the description of flowchart 300 was described in the context of two viewing devices 270, 280 (FIGS. 2A, 2B), embodiments are well suited to three or more viewing devices, as described herein. For example, an apparatus 100 can transmit a video wirelessly to two or more televisions while transmitting data to one or more computer monitors wirelessly or through a cable.

Any one or more of the embodiments described herein can be implemented using computer readable storage medium and computer executable instructions which reside, for example, in computer readable storage medium of a computer system or like device. The computer readable storage medium can be any kind of memory that instructions can be stored on.

Examples of the computer readable storage medium include, but are not limited to, a disk, a compact' disk (CD), a digital versatile device (DVD), read only memory (ROM), flash, and so on. As described above, certain processes and steps of embodiments of the present invention are realized, in one embodiment, as a series of instructions (e.g., software program) that reside within computer readable storage medium of a computer system and are executed by the processor of the computer system. When executed, the instructions cause the computer system to implement the functionality of the embodiments of the present invention.

According to one embodiment, a computer readable storage medium having computer-readable program instructions stored thereon for causing a computer system to perform a method for transmitting 292, 294 (FIGS. 2A, 2B) data from a computer 260A, 260B (FIGS. 2A, 2B) to a plurality of devices 270, 280 (FIGS. 2A, 2B) is provided. The instructions stored on the computer readable storage medium implement a method for receiving first video data from a computer 260A, 260B through a data interface 210 associated with the computer 260A, 2606; transmitting 292 the first video data wirelessly from the computer 260A, 260B to a wireless video receiver 272 associated with a first viewing device 270; and transmitting 294 second data from the computer 260A, 260B to a second viewing device 280 through the data interface 210 and a wireless-pass-through-component 140 (FIG. 1) that is a part of the apparatus 100, wherein the apparatus 100 receives both the first video data and the second data from the computer 260A, 260B through the same data interface 210 and wherein the apparatus 100 transmits 292, 294 both the first video data and the second data.

Various embodiments provide for transmitting video wirelessly to a first viewing device 270 (FIGS. 2A, 2B), such as a television, so that holes are not drilled through walls and floors in order to connect the cables between a computer in their home office and a television that is in their living room or family room. Further, various embodiments provide for transmitting 292, 294 (FIG. 2B) data from a single data interface 210 to a plurality of viewing devices 270, 280 (FIGS. 2B) without using any of the connection slots associated with a computer 260B (FIGS. 2B). For example, if connector 150 transmits data wirelessly to the second viewing device 280, then none of computer 260B's connection slots are used. Various embodiments also provide for transmitting 292, 294 (FIG. 2A) data from a single data interface 210 to a plurality of viewing devices 270, 280 (FIGS. 2A) while using only one connector 250 associated with a computer 260A (FIGS. 2A).

Various embodiments have been described in various combinations. However, any two or more embodiments may be combined. Further, any embodiment may be used separately from any other embodiments.

Example embodiments of the subject matter are thus described. Although various embodiments of the subject matter have been described in a language specific to structural features and/or methodological acts, it is to be understood that the appended claims are not necessarily limited to the specific features or acts described above. Rather, the specific features and acts described above are disclosed as example forms of implementing the claims.

What is claimed is:

1. A method for transmitting data from a computer to a plurality of viewing devices, wherein the method comprises:
receiving, at an apparatus, a first video data from the computer through a data interface associated with the computer;
transmitting the first video data wirelessly from the apparatus to a wireless receiver associated with a first viewing device; and
transmitting second data from the computer to a second viewing device through the computer data interface (210) and a wireless-pass-through-component, which is a part of the apparatus.

2. The method as recited by claim 1, wherein:
the transmitting of the second data further comprises transmitting the second data that is selected from a group consisting of video data that is the same as the first video data, video data that is different than the first video data, and non-video data.

3. The method as recited by claim 1, wherein the transmitting of the first video data wirelessly from the apparatus to the wireless receiver associated with the first viewing device further comprises:
transmitting the first video data to the first viewing device that is a television.

4. The method as recited by claim 1, wherein the transmitting of the second data from the computer to the second viewing device further comprises:
transmitting the second data from the computer to the second viewing device that is a computer monitor.

5. The method according to claim 1, wherein the method further comprises:
receiving the first video data from a first graphics processor;
receiving the second data from a second graphics processor; and
simultaneously transmitting the first video data and the second data.

6. An apparatus for transmitting data to from a computer to a plurality of viewing devices, wherein the apparatus comprises:
a wireless-video-transmitter that is configured to transmit first video data wirelessly, which is received from the computer through the computer data interface, to a wireless-video-receiver associated with a first viewing device;
an second-device-connector configured for communicatively coupling the apparatus to a second viewing device; and
a wireless-pass-through-component that is configured to transmit second data from the computer to the second viewing device through the second-device-connector, wherein the second-device-connector and the wireless-pass-through-component are hardware components.

7. The apparatus of claim 6, wherein the first viewing device and the second viewing device are selected from a group consisting of a television and a computer monitor.

8. The apparatus of claim 6, wherein the apparatus is selected from a group consisting of an apparatus that is separate from the computer and an apparatus that resides on the computer.

9. The apparatus of claim 6, wherein the apparatus is further configured for transmitting the first video data and transmitting the second data simultaneously, wherein the first video data and the second data are obtained from separate graphics processors that reside on the computer.

10. The apparatus of claim 6, wherein the apparatus conform to a standard selected from a group consisting of High Definition (HD), High Definition Multimedia Interface (HDMI), Video Graphics Array (VGA), and Digital Visual Interface (DVI).

11. A computer readable storage medium having computer-readable program instructions stored thereon for causing a computer system to perform a method for transmitting data from a computer to a plurality of devices, the method comprising:
Receiving first video data from a computer through a data interface associated with the computer;
transmitting the first video data wirelessly from the computer to a wireless video receiver associated with a first viewing device; and transmitting second data from the computer to a second viewing device through the data interface and a wireless-pass-through-component that is a part of the apparatus, wherein the apparatus receives both the first video data and the second data from the computer through the same data interface and wherein the apparatus transmits both the first video data and the second data.

12. The computer readable storage medium of claim 11, wherein the transmitting of the second data further comprises:
transmitting the second data from the computer to the second viewing device through the wireless-pass-through-component that is a part of the apparatus, wherein the apparatus is selected from a group consisting of an apparatus that is separate from the computer and an apparatus that resides on the computer.

13. The computer readable storage medium of claim 11 wherein the method further comprises:
receiving the first video data from a first graphics processor;
receiving the second data from a second graphics processor; and
simultaneously transmitting the first video data and the second data.

14. The computer readable storage medium of claim 11, wherein the method further comprises:
receiving the first video data from the computer through a high definition multimedia interface (HDMI) interface associated with the computer;
transmitting the first video data wirelessly to an HDMI wireless video receiver associated with the first viewing device; and transmitting the second data to the second viewing device through the single HDMI interface and a wireless-HDMI-pass-through-component that is a part of the apparatus, wherein the apparatus receives both the first video data and the second data from the computer through the same HDMI interface and wherein the apparatus transmits both the first video data and the second data.

15. The computer readable storage medium of claim 11, wherein the method further comprises:
transmitting the first video data and transmitting the second data to viewing devices that are selected from a group consisting of televisions and computer monitors.
